(19) United States
(12) Patent Application Publication
(10) Pub. No.: US 2009/0314109 A1
(43) Pub. Date: Dec. 24, 2009

(54) Interface Module for Motor and Gearbox

(76) Inventor: Yu-Ta Tu, Taipei City (TW)

Correspondence Address: David Shung, P.O. Box 10557, Taipei, 100, TW

(21) Appl. No.: 12/485,993

(22) Filed: Jun. 17, 2009

(30) Foreign Application Priority Data
Jun. 20, 2008 (TW) 097210901

(51) Int. Cl. F16H 37/00

(52) U.S. Cl. 74/15.63; 464/182

(57) ABSTRACT

An interface module for connecting a motor and a gearbox is disclosed. The interface module includes a gearbox cover for covering the gearbox and a connecting member disposed therein. The connecting member has a first face and a second face. The first face and the second face connect to an output shaft of a motor and a torque converter of the gearbox, respectively. The modulized interface can simplify components matching the motor and gearbox when their specifications change. For example, the motor does not need to change when specification of the gearbox changes. Thus compatibility of gearbox or motor can be improved with less limitation of changing different makers or specifications.

### BACKGROUND OF THE INVENTION

1. Technical Field

The invention generally relates to power transmissions, particularly to interfaces between power sources and gearboxes.

2. Related Art

In a conventional automobile, an engine drives wheels by means of a torque converter of gearbox. A gearbox made by a car manufacture can not be used to couple an engine made by another car manufacture due to a compatibility problem. If a user wants to change a different brand of gearbox, he or she must proceed with complicated engineering for matching. It is very uneconomical.

On the other side, electric vehicles will become more important than ever because of rises in petroleum price and awareness of environmental protection. Motors are a primary power source of electric vehicles. When we want to replace an engine with an electric motor, the first difficulty is the problem of compatibility between the motor and gearbox. An output shaft of a motor can not match an existing gearbox for an engine.

### SUMMARY OF THE INVENTION

An object of the invention is to provide an interface module for a motor and a gearbox which improves compatibility between a motor and a gearbox with less limitation of changing different makers or specifications. Furthermore, the invention can be used in an electric car which is made by replacing an engine with a motor. Thus the production or adaptation costs can be effectively reduced.

To accomplish the above object, the invention provides an interface module for connecting a motor and a gearbox. The interface module includes a gearbox cover for covering the gearbox and a connecting member disposed therein. The connecting member has a first face and a second face. The first face and the second face connect to an output shaft of a motor and a torque converter of the gearbox, respectively. The modulized interface can simplify components matching the motor and gearbox when their specifications change. For example, the motor does not need to change when specification of the gearbox changes. Thus compatibility of gearbox or motor can be improved with less limitation of changing different makers or specifications.

### BRIEF DESCRIPTION OF THE DRAWINGS

FIG. 1 is an exploded view of the invention;

FIG. 2 is a sectional view of the invention;

FIG. 3 shows the gearbox cover of the invention;

FIG. 4 shows the connecting member of the invention; and

FIG. 5 shows the output shaft of the motor of the invention.

### DETAILED DESCRIPTION OF THE INVENTION

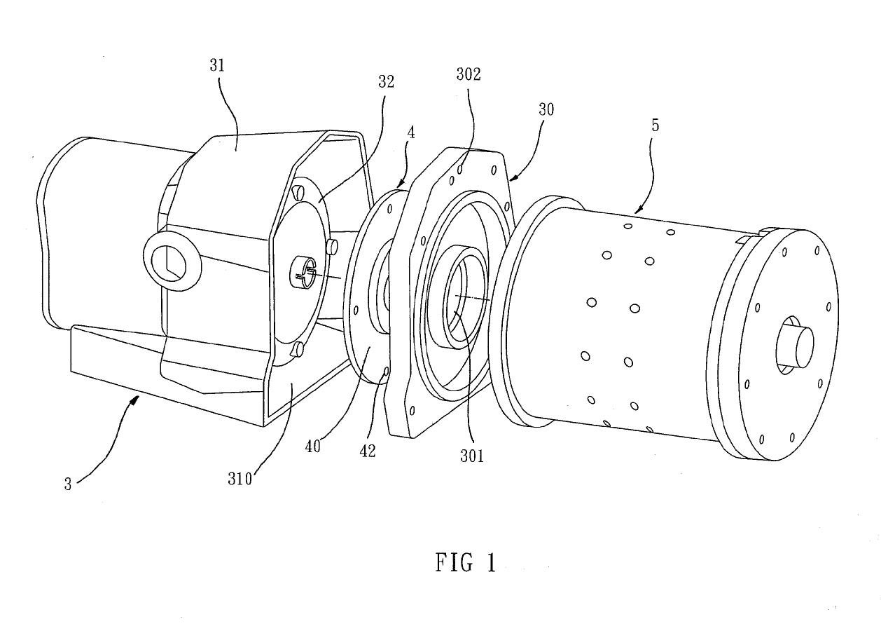

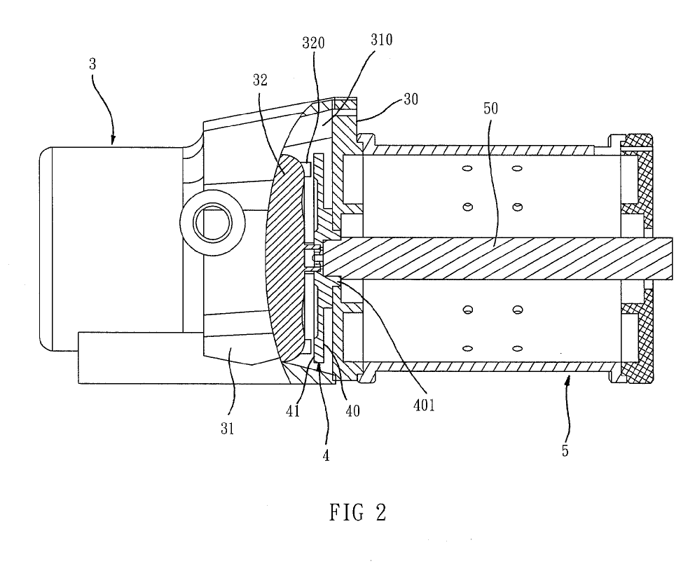

Referring to FIGS. 1 and 2, the invention includes a gearbox cover 30 for covering the gearbox 3 and a connecting member 4 disposed therein. The connecting member 4 has a first face 40 and a second face 41. The first face 40 and the second face 41 connect to an output shaft 50 of a motor 5 and a torque converter 32 of the gearbox 3, respectively.

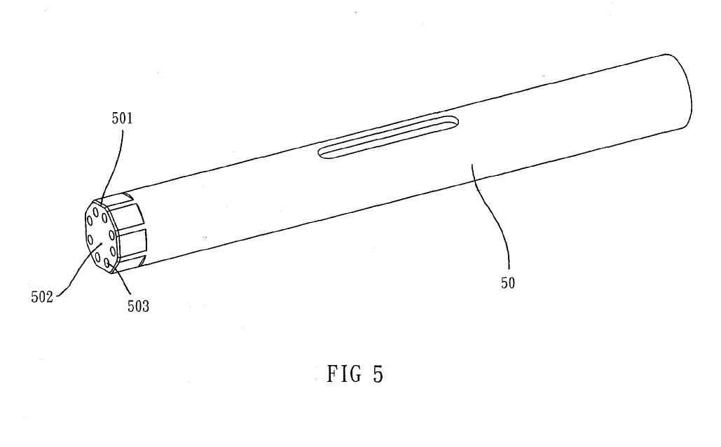

The abovementioned components are disposed in an order as gearbox 3, connecting member 4, gearbox cover 30 and motor 5. In other words, the connecting member 4 is disposed between the gearbox 3 and the gearbox cover 30, and the gearbox cover 30 is disposed between the motor 5 and the connecting member 4. The output shaft 50 of the motor 5 penetrates the gearbox cover 30 to connect the connecting member 4. Further referring to FIG. 5, a free end of the output shaft 50 for driving the gearbox 3 has a polygonal driving portion 501. An end face 502 of the driving portion 501 is provided with a plurality of connecting holes 503 for connecting with the connecting member 4 to constitute a driving connection.

The gearbox 3 has an outer shell 31. The torque converter 32 is accommodated in the outer shell 31. Usually, the torque converter 32 is provided with installation portions 320 for connecting with an engine. Besides, the outer shell 31 has an open portion 310 facing the motor 5. The open portion 310 allows the output shaft 50 to enter the outer shell 31 for connecting with the torque converter 32 through the connecting member 4.

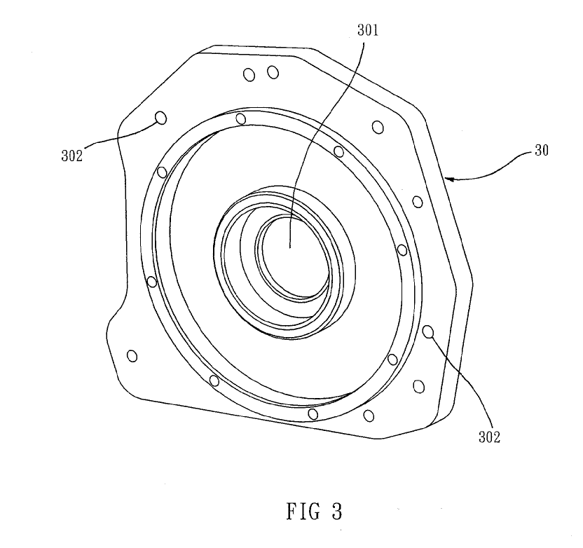

Referring to FIG. 3, the gearbox cover 30 has an outline corresponding to the open portion 310. The gearbox cover 30 has a passing hole 301 for being penetrated by the output shaft 50. There are fixing holes 302 around the passing hole 301 in the gearbox cover 30. The gearbox cover 30 is fixed on the outer shell 31 of the gearbox 3 by the fixing holes 302 to cover the open portion 310.

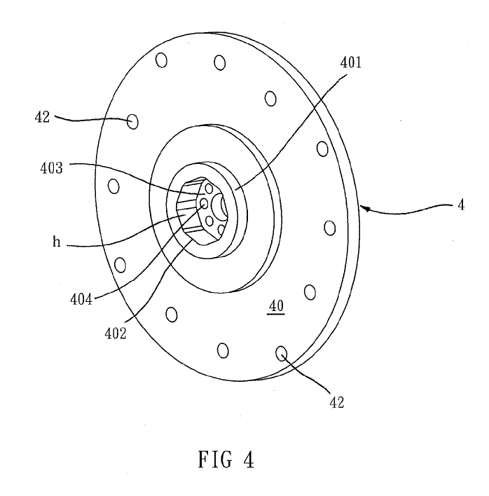

Referring to FIG. 4, the connecting member 4 has a shaft sleeve 401 near a center thereof and extruding towards the motor 5. There is a shaft hole 402, which has a shape corresponding to the output shaft 50 of the motor S and which has a certain depth “h”, in the shaft sleeve 401. In detail, the shape of the shaft hole 402 is of a polygon matching the driving portion 501 of the output shaft 501. Thereby, the output shaft 50 can drive the connecting member 4 to rotate when the output shaft 50 is inserted into the shaft hole 402. Preferredly, a bottom 403 of the shaft hole 402 is provided with positioning holes 403 corresponding to the connecting holes 503 of the output shaft 50. By the fixedly connection between the positioning holes 404 and the connecting holes 503, the coupling of the output shaft 50 and the connecting member 4 can be more secure.

The connecting member 4 is provided with a plurality of installing holes 42 around the shaft sleeve 401. The installing holes 42 penetrate the first face 40 and the second face 41, and correspond to the installation portions 320 of the torque converter 32 of the gearbox 3. This makes the connecting member 4 fixedly connect the torque converter 32. In other words, the output shaft 50 of the motor 5 synchronously drives the torque converter to operate when the connecting member 4 is driven by the motor 5.

In sum, the advantages of the invention are that:
(1) the exchangeability of either of motors and gearboxes can be improved with less limitation of a specific brand or specification so that a motor can match different models of gearboxes.
(2) the production or adaptation costs can be reduced because the invention can be in those cars replacing an engine with a motor.
(3) the gearbox can be completely sealed by the gearbox cover for preventing foreign matters from entering the gear box.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. An interface module for connecting between a motor and a gearbox, wherein the motor has an output shaft, the gearbox is provided with an outer shell having an open portion towards the motor, a torque converter is accommodated in the outer shell, the open portion of the gearbox is sealed by a gearbox cover, and the gearbox cover has a passing hole for being penetrated by the output shaft, the interface module comprising:
a connecting member, disposed in the open portion of the gearbox, being of a disk shape, having a first face and a second face opposite the first face, the first face being provided with a shaft sleeve towards the motor, and the shaft sleeve has a shaft hole for coupling with the output shaft;
thereby the motor can drive the torque converter of the gearbox through the connecting member.

2. The interface module of claim 1, wherein the torque converter is provided with installation portions, the connecting member is provided with a plurality of installing holes around the shaft sleeve, and the installing holes penetrate the first face and the second face, and correspond to the installation portions.

3. The interface module of claim 1, wherein an end face of a free end of the output shaft is provided with a plurality of connecting holes, and a bottom of the shaft hole is provided with positioning holes corresponding to the connecting holes.

4. The interface module of claim 2, wherein an end face of a free end of the output shaft is provided with a plurality of connecting holes, and a bottom of the shaft hole is provided with positioning holes corresponding to the connecting holes.

5. The interface module of claim 1, wherein a free end of the output shaft has a polygonal driving portion, and the shaft hole of the connecting member is a polygon corresponding to the driving portion.

6. The interface module of claim 2, wherein a free end of the output shaft has a polygonal driving portion, and the shaft hole of the connecting member is a polygon corresponding to the driving portion.

7. The interface module of claim 3, wherein a free end of the output shaft has a polygonal driving portion, and the shaft hole of the connecting member is a polygon corresponding to the driving portion.
